(19) United States
(12) Patent Application Publication
(10) Pub. No.: US 2008/0043159 A1
(43) Pub. Date: Feb. 21, 2008

(54) LIQUID CRYSTAL DISPLAY CAPABLE OF REDUCING CURRENT LEAKAGE

(75) Inventors: Chih-wei Wang, Hsin-Chu City (TW); Chin-der Wey, Hsin-Chu City (TW); Chia-hung Sun, Hsin-Chu City (TW); Tsung-shiun Lee, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu (TW)

(21) Appl. No.: 11/689,202

(22) Filed: Mar. 21, 2007

(30) Foreign Application Priority Data
Aug. 16, 2006 (TW) 095130142

(51) Int. Cl. G02F 1/133

(52) U.S. Cl. 349/33

(57) ABSTRACT

A liquid crystal display capable of reducing current leakage includes a printed circuit board, a plurality of light sources, a power controller disposed on the printed circuit board, a bridge converter disposed on the printer circuit board, a first transformer, a second transformer, and a liquid crystal panel. The plurality of light sources are used for generating light, and each light source includes a first end and a second end. The power controller is used for generating power driving signal. The bridge converter is used for generating a supply voltage signal based on the power driving signal. The first transformer is used for transforming the supply voltage signal into a first operating signal to each first end of the plurality of light sources. The second transformer is used for transforming the supply voltage signal into a second operating signal to each second end of the plurality of light sources. The liquid crystal panel comprises a liquid crystal layer for adjusting light from the plurality of light sources to display an image.

### BACKGROUND OF THE INVENTION

1. Field of the Invention

The present invention relates to a liquid crystal display, and more specifically, to a liquid crystal display capable of reducing current leakage.

2. Description of the Related Art

With a rapid development of monitor types, novelty and colorful monitors with high resolution, e.g., liquid crystal displays (LCDs), are indispensable components used in various electronic products such as monitors for notebook computers, personal digital assistants (PDA), digital cameras, and projectors. The demand for the novelty and colorful monitors has increased tremendously.

Most of the TFT-LCDs utilize Cold Cathode Fluorescent Lamps (CCFL) as backlight sources. The CCFL can emit light when noble gas inside the lamp is driven by a high-frequency driving voltage. In addition, the required driving voltage increases as CCFL length increases. Yet, the current leakage also increases as CCFL length increases and an increase in the operating voltage. Therefore, the length of the CCFL and the operating voltage applied to the CCFL are associated with an increasing amount of current leakage.

Conventionally, a commonly-used method of enabling the CCFL is to apply a high frequency driving voltage on one end of the CCFL and the other end is coupled to ground or to be floated. As a result, as can be seen in FIG. 1, which shows a relationship between the operating voltage Vₗₐₘₚ and the current leakage I_{L}, the higher the operating voltage Vₗₐₘₚ is, the non-linearly greater the current leakage is. As an example, the current leakage I1 in response to the operating voltage V1 is greater than current leakage I3 in response to the operating voltage V3 (=V1×½) by more than doubled. Furthermore, a decrease in current is varied as an increase in distance far from the high voltage end of the CCFL, thereby incurring uneven display quality and uneven brightness contrast.

In order to overcome such problem, applying operating voltages which have identical frequencies and identical amplitudes but reversed phase on two ends of CCFL is a resolution. Since each amplitude of the operating voltages applied to the two ends of the CCFL is half of the required voltage applied to a single end of the CCFL, the CCFL driven by operating voltages applied to the two ends of the CCFL induces less current leakage. However, such configuration requires two inverters to generate two operating voltages, not only raising the cost of the LCD, but also occupying more space for arranging two inverters.

As a result, a development of a liquid crystal display, capable of reducing current leakage compared to the LCD driven by operating voltage applied to single end, and capable of reducing cost in the LCD driven by operating voltage applied to two ends, is necessary.

### SUMMARY OF THE INVENTION

The present invention provides a liquid crystal display capable of reducing current leakage. The liquid crystal display comprises a printed circuit board, a plurality of light sources, a power controller disposed on the printed circuit board, a bridge converter disposed on the printer circuit board, a first transformer, a second transformer, and a liquid crystal panel. The plurality of light sources are used for generating light, and each light source comprises a first end and a second end. The power controller is used for generating power driving signal. The bridge converter is used for generating a supply voltage signal based on the power driving signal. The first transformer is used for transforming the supply voltage signal into a first operating signal to each first end of the plurality of light sources. The second transformer is used for transforming the supply voltage signal into a second operating signal to each second end of the plurality of light sources. The liquid crystal panel comprises a liquid crystal layer for adjusting light from the plurality of light sources to display an image.

According to the present invention, a liquid crystal display comprises a printed circuit board, a plurality of light sources, a power controller disposed on the printed circuit board, a first bridge converter coupled to the power controller, a second bridge converter coupled to the power controller, a first transformer disposed on the printed circuit board, a second transformer, and a liquid crystal panel. The plurality of light sources are used for generating light, and each light source comprises a first end and a second end. The power controller is used for generating power driving signal. The first bridge converter is used for generating a first supply voltage signal based on the power driving signal. The second bridge converter is used for generating a second supply voltage signal based on the power driving signal. The first transformer is used for transforming the first supply voltage signal into a first operating signal to each first end of the plurality of light sources. The second transformer is used for transforming the second supply voltage signal into a second operating signal to each second end of the plurality of light sources. The liquid crystal panel comprises a liquid crystal layer for adjusting light from the plurality of light sources to display an image.

The present invention will be described with references to the accompanying drawings, which show example embodiments thereof and are incorporated in the specification hereof by related references.

### BRIEF DESCRIPTION OF THE DRAWINGS

FIG. 1 shows a relationship between the operating voltage Vₗₐₘₚ and the current leakage I_{L}.

FIG. 2 illustrates a liquid crystal display (LCD) according to a first embodiment of the present invention.

FIG. 3 shows a schematic diagram of current leakage when a light source of FIG. 2 is being driven.

FIG. 4 illustrates a liquid crystal display (LCD) according to a second embodiment of the present invention.

### DETAILED DESCRIPTION OF THE PREFERRED EMBODIMENT

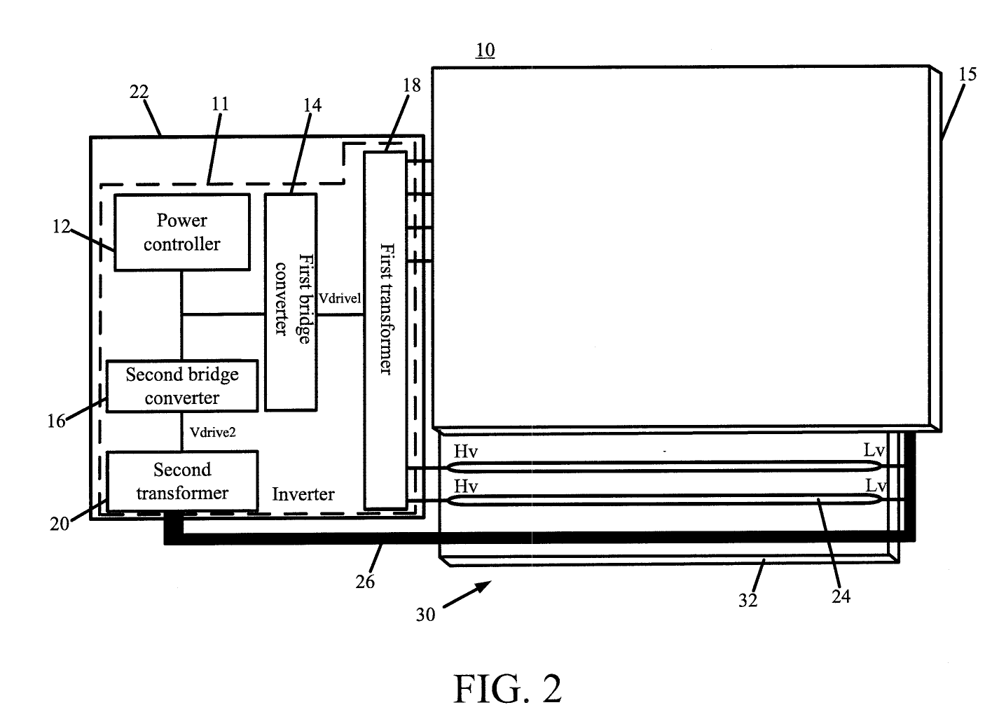

With reference to FIG. 2 illustrating a liquid crystal display (LCD) 10 according to a first embodiment of the present invention, the LCD 10 comprises an LCD panel 15, an inverter 11, and a backlight module 30. The inverter 11 comprises a power controller 12, a first bridge converter 14, a second bridge converter 16, a first transformer 18, and a second transformer 20, all of which are disposed on a printed circuit board 22. The backlight module 30 comprises a plurality of light sources 24 enclosed by a metal bezel 32 for providing sufficient light for the LCD 10. The plurality of light sources 24, such as cold cathode fluorescent lamps (CCFLs), generate light based on driving voltage provided by the driver 11. The liquid crystal panel 15 comprises a liquid crystal layer filled with liquid crystal molecules. An alignment of the molecules is varied based on image data to adjust the light emitted from the light second transformer 20 and the plurality of light sources 24.

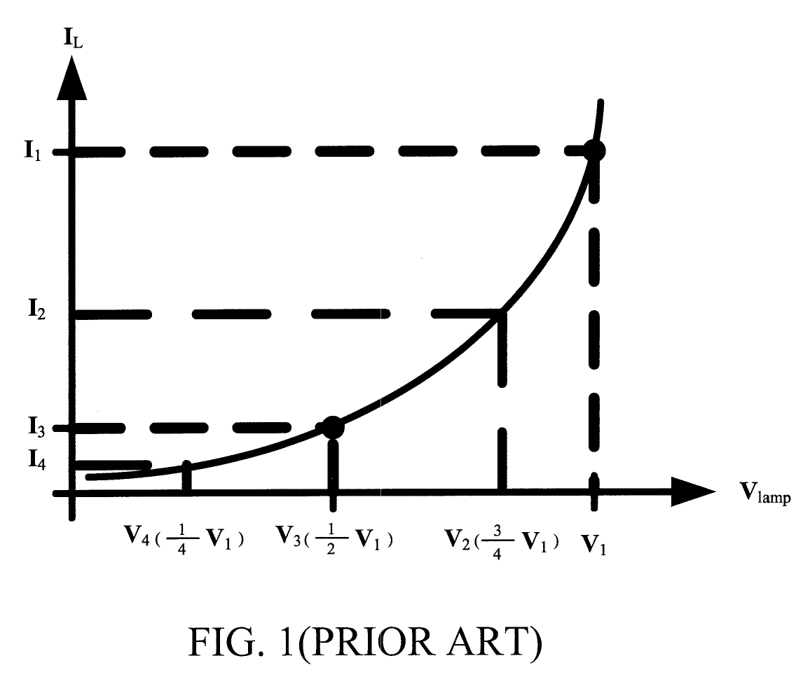

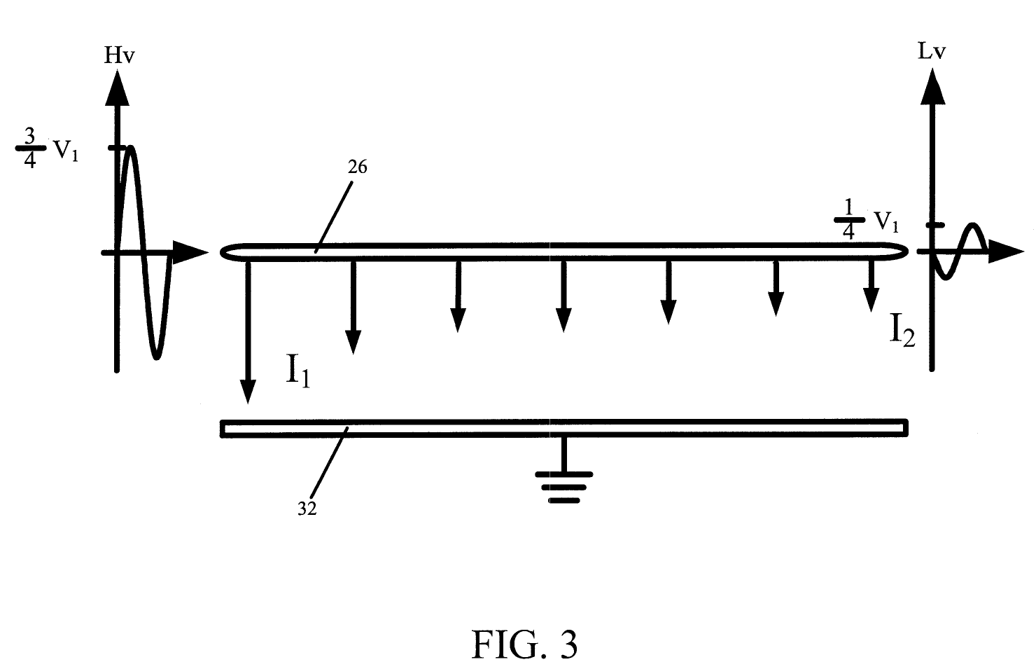

Referring to FIGS. 1, 2 and 3, FIG. 3 shows a schematic diagram of current leakage when a light source 24 of FIG. 2 is being driven. The power controller 12 generates a power driving signal to the first and second bridge converters 14, 16. The first bridge converter 14 can generate a first supply voltage signal Vdrive1 to the first transformer 18 according to a width of the power driving signal, while the second bridge converter 16 can generate a second supply voltage signal Vdrive2 to the second transformer 20 according to a width of the power driving signal. Then, the first transformer 18 transforms the first supply voltage signal Vdrive1 into a first operating signal to a first end Hv of the plurality of light sources 24, while the second transformer 20 transforms the second supply voltage signal Vdrive2 into a second operating signal to a second end Lv of the plurality of light sources 24. Preferably, the first operating signal has reversed phase to the second operating signal (i.e. a phase difference between the first operating signal and the second operating signal is 180 degrees, and the amplitude of the first operating signal is different from that of the second operating signal. For instance, suppose that the required amplitude of the driving voltage Vlamp of the light source 24 is 1200 Volts (V), under this circumstance, an amplitude of the first operating signal may be 900V and an amplitude of the second operating signal may be 300V, but phases of such two driving signals are exactly reversed (i.e. the phase difference between the two signals is 180 degrees), So that the entire amplitudes of the two driving signals are 1200V which is consistent with the required amplitude of the driving voltage Vlamp of the light source 24. As depicted in FIG. 3, a gap between the light source 24 and the metal bezel 32 of the backlight module 30 equivalent to a capacitor induces the current leakage. Referring to FIG. 3, the current leakage nonlinearly increases as the voltage drop across the light source 24 and the metal bezel 32. For example, when the driving voltage drop V1 is applied to the light source 24, the amplitude of the first operating signal applied to the first end Hv is a value of V2(=0.75×V1), inducing a current leakage I2(<0.75×I1), while the amplitude of the second operating signal applied to the second end Lv is a value of V4(=0.25×V1), inducing a current leakage I4(<0.25×I1). Compared with the light source driven by a driving signal of a voltage amplitude V1 applied to single end of the light source and the other end being ground, the total current leakage 11 is induced at the two ends. As a result, the total current leakage (I2+I4) at the two ends of the light source of this embodiment (as shown in FIG. 3) is less than the total current leakage (I1+0) at the two ends of the light source of which one end is applied to a driving signal of a voltage amplitude V1 and the other end is ground. In doing so, the whole current leakage of the light source driven by unsymmetrical voltages is less than that of the light source driven by a single end.

As it is, the second transformer 20 can be disposed on a second printed circuit board where the area is smaller than the area of the printed circuit board 22, such that the LCD 10 can flexibly arrange in space.

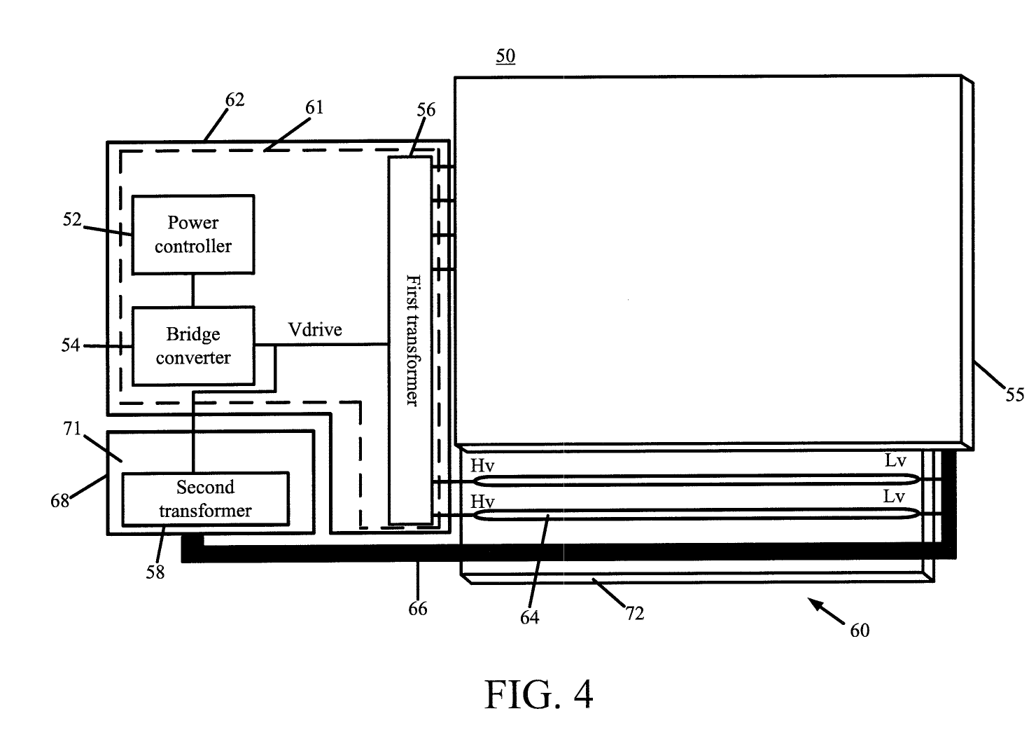

With reference to FIG. 4 illustrating a liquid crystal display (LCD) 50 according to a second embodiment of the present invention, the LCD 50 comprises an LCD panel 55, a main inverter 61, a slave inverter 71, and a backlight module 60. The main inverter 61 comprises a power controller 52, a bridge converter 54, and a first transformer 56, all of which are disposed on a first printed circuit board 62. The slave inverter 71 comprises a second transformer 58 disposed on a second printer circuit board 68. The backlight module 60 comprises a plurality of light sources 64 enclosed by a metal bezel 72 for providing sufficient light for the LCD 50. The plurality of light sources 64, such as cold cathode fluorescent lamps (CCFLs), generate light based on driving voltage provided by the main driver 61 and the slave inverter 71. The liquid crystal panel 55 comprises a liquid crystal layer filled with liquid crystal molecules. An alignment of the molecules is varied based on image data to adjust the light emitted from the light sources 64, thereby displaying various grey levels.

The power controller 52 generates a power driving signal to the bridge converter 54. The bridge converter 54 can generate a supply voltage signal Vdrive to the first transformer 56 and the second transformer 58 according to a width of the power driving signal. Then, the first transformer 56 and the second transformer 58 transform the supply voltage signal Vdrive into a first operating signal and a second operating 64, while the second operating signal is fed to a second end Lv of the plurality of light sources 24. Preferably, the first operating signal has reversed phase to the second operating signal, i.e. a phase difference between the first operating signal and the second operating signal is 180 degrees, and the amplitude of the first operating signal is different from that of the second operating signal.

Differing from the LCD 10 shown in FIG. 2, both the first transformer 56 and the second transformer 58 are connected in parallel to the bridge converter 54. Also, a ratio in turns of the first transformer 56 is different from that of the second transformer 58. In this way, despite being fed the same supply voltage signal Vdrive, the first and second transformers 56 and 58 can respectively output the first operating signal and the second signal having different amplitudes. As a result, each light source 64 is driven by the first and the second operating signals to emit light

Because the area of the second printed circuit board 68 is smaller than that of the first printed circuit board 62, the LCD 50 can be flexibly arranged in space. A cable 66 is used for electrically connecting the second transformer 58 and the plurality of light source 64.

Similar to the operating principle illustrated in FIG. 2, the total current leakage at the two ends of the light source 64 of this embodiment (as shown in FIG. 4) is less than the total current leakage (I1+0) at the two ends of the light source of which one end is applied to a driving signal of a voltage amplitude V1 and the other end is ground. In doing so, the whole current leakage of the light source driven by unsymmetrical voltages is less than that of the light source driven by a single end.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display comprising:
a printed circuit board;
a plurality of light sources for generating light, each light source comprising a first end and a second end;
a power controller, disposed on the printed circuit board, for generating a power driving signal;
a bridge converter, disposed on the printer circuit board, for generating a supply voltage signal in response to the power driving signal;
a first transformer for transforming the supply voltage signal into a first operating signal to each first end of the plurality of light sources;
a second transformer for transforming the supply voltage signal into a second operating signal to each second end of the plurality of light sources; and
a liquid crystal panel comprising a liquid crystal layer for adjusting light from the plurality of light sources to display an image.

2. The liquid crystal display of claim 1, further comprising a second printed circuit board for supporting the second transformer.

3. The liquid crystal display of claim 1, wherein the plurality of light sources are cold cathode fluorescent lamps.

4. The liquid crystal display of claim 1, wherein a phase difference between the first operating signal and the second operating signal is 180 degrees.

5. The liquid crystal display of claim 4, wherein an amplitude of the first operating signal is different from an amplitude of the second operating signal.

6. The liquid crystal display of claim 1, wherein the bridge converter generates the supply voltage signal in response to a width of the power driving signal.

7. The liquid crystal display of claim 1, further comprising a cable for electrically connecting the second transformer and the bridge converter.

8. The liquid crystal display of claim 1, wherein the first transformer and the second transformer is connected in parallel with the bridge converter.

9. A liquid crystal display comprising:
a printed circuit board;
a plurality of light sources for generating light, each light source comprising a first end and a second end;
a power controller disposed on the printed circuit board, for generating a power driving signal;
a first bridge converter electrically coupled to the power controller, for generating a first supply voltage signal in response to the power driving signal;
a second bridge converter electrically coupled to the power controller, for generating a second supply voltage signal in response to the power driving signal;
a first transformer disposed on the printed circuit board, for transforming the first supply voltage signal into a first operating signal to each first end of the plurality of light sources;
a second transformer for transforming the second supply voltage signal into a second operating signal to each second end of the plurality of light sources; and
a liquid crystal panel comprising a liquid crystal layer for adjusting light from the plurality of light sources to display an image.

10. The liquid crystal display of claim 9 further comprising a second printed circuit board for supporting the second transformer.

11. The liquid crystal display of claim 9 wherein the plurality of light sources are cold cathode fluorescent lamps.

12. The liquid crystal display of claim 9 wherein a phase difference between the first operating signal and the second operating signal is 180 degrees.

13. The liquid crystal display of claim 12 wherein an amplitude of the first operating signal is different from an amplitude of the second operating signal.

14. The liquid crystal display of claim 9 wherein the bridge converter generates the supply voltage signal in response to a width of the power driving signal.

15. The liquid crystal display of claim 9 further comprising a cable for electrically connecting the second transformer and the bridge converter.
